(19) United States
(12) Patent Application Publication
(10) Pub. No.: US 2001/0045261 A1
(43) Pub. Date: Nov. 29, 2001

(54) Method of fabricating a flexible graphite laminate with a metal core

(76) Inventors: Robert Angelo Mercuri, Seven Hills, OH (US); Edwin John Ohneth, North Olmsted, OH (US)

Correspondence Address: James R. Cartiglia, Graftech Inc., Suite 1100, 3102 West End Avenue, Nashville, TN, 37203, US

(21) Appl. No.: 09/915,158

(22) Filed: Jul. 25, 2001

Related U.S. Application Data
(63) Continuation of application No. 09/393,980, filed on Sep. 10, 1999, now abandoned.
Application No. 09/393,980 is a continuation-in-part of application No. 08/910,476, filed on Jul. 25, 1997, now abandoned.
Application No. 08/910,476 is a continuation of application No. 08/393,236, filed on Feb. 23, 1995, now abandoned.
Application No. 08/393,236 is a continuation of application No. 08/122,044, filed on Sep. 14, 1993, now abandoned.
Application No. 08/122,044 is a continuation of application No. 07/879,447, filed on May 1, 1992, now abandoned.
Application No. 07/879,447 is a continuation of application No. 07/693,547, filed on Apr. 30, 1991, now abandoned.

(51) Int. Cl. C09J 5/00

(52) U.S. Cl. 156/324

(57) ABSTRACT

A method of fabricating a bonded flexible graphite laminate having an intermediate core of metal bonded on opposite sides to a flexible graphite sheet through a polymerized phenolic resin bonding agent under controlled conditions which avoids surface blistering and produces a chemical bond impervious to an organic solvent.

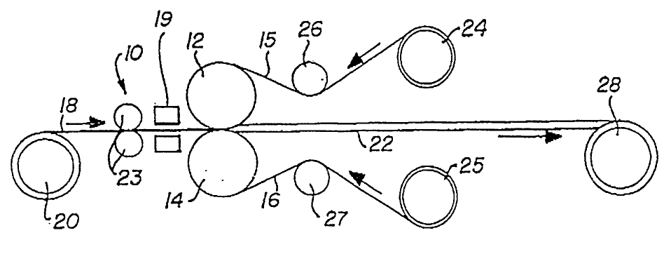

This invention relates to a method of fabricating a flexible graphite laminate with a metal core.

### BACKGROUND OF THE INVENTION

A flexible graphite facing reinforced with steel to form a laminated flexible graphite-to-steel gasket is presently used in the automotive industry as a gasket replacement for the gasket sealing in the automotive engine block and head. The laminate is formed by impressing a flexible graphite facing over a metal sheet containing multiple tangs which perforate the flexible graphite facing. This is followed by a calendering operation which flattens the perforated tangs to mechanically interlock the laminate. This procedure limits the practical maximum thickness of the steel core to a limited range between 0.004 inches to about 0.010 inches thick. A flexible graphite laminate with a thicker or thinner reinforcing core bonded to the flexible graphite facing is often preferred.

A flexible graphite laminate having an interlayer can also be formed as taught in U.S. Pat. No. 4,961,991 by interposing a polymer resin coated cloth of e.g. polytetrafluroethylene between two sheets of flexible graphite to permit the sheets to be adhesively bonded at elevated temperature. This is an expensive alternative to the above described mechanical assembly. The use of a thermosetting adhesive for bonding the graphite sheets to a metal core would be preferable provided it does not cause blistering to occur at the elevated temperatures required to cure the thermosetting composition and forms a chemically and thermally stable bond impervious to organic solvents.

### SUMMARY OF THE INVENTION

The metal laminate of the present invention is formed with a core of metal bonded to a flexible graphite sheet through a polymerized phenolic resin bonding agent under controlled conditions which avoids surface blistering and produces a chemically and thermally stable bond impervious to organic solvents.

The method of the present invention for fabricating an adhesively bonded laminate composed of at least one sheet of metal and a sheet of flexible graphite comprises the steps of:

preparing a fluid adhesive composition comprising a phenolic resin, a diluent and a compound of natural or synthetic rubber;

feeding said sheet of metal simultaneously with said sheet of flexible graphite through a calender roll assembly in a superimposed relationship;

interposing said fluid adhesive composition between said sheet of flexible graphite and said sheet of metal before said sheets are calendered to form said laminate;

discharging said laminate of flexible graphite and metal from said calender roll assembly; and

heating said discharged laminate gradually and at a slow rate of no more than 25° C. per hour until a temperature is reached sufficient to polymerize said phenolic resin and vaporize said rubber compound from said adhesive composition without blistering said flexible graphite.

### BRIEF DESCRIPTION OF THE DRAWING

The preferred embodiment for carrying out the invention is schematically illustrated in the single FIGURE.

### DETAILED DESCRIPTION OF THE INVENTION

The term “flexible graphite” as used herein is the product obtained by compressing the exfoliated reaction product of rapidly heated graphite particles which have been treated with an agent capable of intercalating into the crystal structure of the graphite to expand the particles at least 80 or more times in the direction perpendicular to the carbon layers in the crystal structure as taught in U.S. Pat. No. 3,404,061, the disclosure of which is incorporated herein by reference. Flexible graphite may be compressed into a thin sheet of between 5-25 mils in thickness with a density approaching theoretical density, although a density of about 70 lbs/ft³ is acceptable for most applications.

A laminate of flexible graphite and a core of metal of e.g. steel or aluminum is formed in accordance with the method of the present invention using a calender roll assembly 10 as shown in the drawing. The calender roll assembly includes two rolls 12 and 14 aligned relative to one another to calender two sheets of flexible graphite 15 and 16 into engagement, preferably under a pressure of between 100-200 psi, with an interposed sheet 18 of metal. The sheet of metal 18 is fed from an unwind supply roll 20 between the two sheets of flexible graphite 15 and 16 for forming a laminate 22 with the flexible graphite sheets 15 and 16 superimposed on the metal sheet 18. An applicator 23 is located in-line to apply a suitable thermosetting adhesive composition between the engaging surfaces of the metal sheet 18 and the sheets of flexible graphite 15 and 16 to form a chemical bond between such engaging surfaces. A dryer 19 is located downstream of the applicator 23 to dry the adhesive composition. The dryer 19 may be an air dryer or a radiant heater.

The flexible graphite sheets 15 and 16 are fed from supply rolls 24 and 25 around idler rolls 26 and 27 and then over calendering rolls 12 and 14 to a take-up roll 28. In accordance with the method of the present invention the calendering rolls 12 and 14 should be preheated to bond the laminate 22 at an elevated temperature of between 100° F. to 300° F.

The laminate 22 formed between the rolls 12 and 14 consists of two flexible graphite sheets 15 and 16 on opposite sides of a center core of a metal sheet 18. The calender roll assembly 10 can also be used to form a single coated laminate with only one flexible graphite sheet 15 or 16. The assembly 10 may also be modified using additional rollers (not shown) to form a laminate having multiple sheets each of which are bonded together by the adhesive composition 23 under nominal pressure of between 100-200 psi at the above designated temperature.

The adhesive composition applied by the applicator 23 is a thermosetting phenolic resin modified with the addition of a synthetic or natural rubber compound and a diluent of preferably an alcohol such as isopropanol or isopropyl alcohol or methyl ethyl ketone. The concentration of the diluent should be sufficient to liquify the composition so that it may be applied by spraying, roll coating or brushing onto the opposite surfaces of the metal sheet 18 and/or over the opposed surfaces of the flexible graphite sheets 15 and 16 which engage the sheet 18. Alternatively, the adhesive composition may be directly applied to the flexible graphite sheets 15 and 16 and dried before they are superimposed on the center core and passed through the calender rolls 12 and 14. The calender rolls 12 and 14 are adjusted to apply a nominal pressure of between 100-200 psi to the laminated sheets and are preferably preheated to a temperature of between 100° F. to 300° F. The phenolic composition should include up to 10% by weight of a natural or synthetic rubber compound such as neoprene or butadiene. The rubber compound assures uniform contact between the metal sheet 18 and the sheets of flexible graphite 15 and 16 respectively. A suitable adhesive composition is available commercially and sold under the designation HRJ-2903 by Schenectady Chemicals Inc.

The laminate 22 is subjected to a post heat treatment operation to polymerize the phenolic resin and to release volatiles from the adhesive composition. The post heat treatment must be carried out in a gradual manner by incrementally increasing the temperature to avoid blistering of the flexible graphite sheets and possibly, delamination. The flexible graphite sheets 15 and 16 are essentially non-porous in the direction transverse to the plane of the sheet 18. Accordingly, the temperature must be raised gradually at a slow enough rate to permit the volatiles to escape through the flexible graphite in a direction parallel to the longitudinal. The temperature should be increased at no more than 250° C. per hour and preferably between 10-15° C. per hour until a temperature is reached sufficient to cause polymerization of the phenolic. A temperature of at least 200° C. is necessary to cure the phenolic and preferably over 300° C. with 330° C. being preferred. Once cured the laminate 23 is impervious to delamination in the presence or an organic solvent such as methy ethyl ketone.

Blistering and delamination may be entirely avoided without the necessity for a post heat treatment operation or limited solely to an on-line heat treatment of the laminant following calendering with the heat treatment limited to a time interval of only minutes and up to a maximum heat treatment of ½ hour as opposed to the very slow and gradual post curing time interval measured in hours as indicated heretofore. This may be accomplished by practicing the invention subject to the following steps prior to calendering:

1. (1) The phenolic resin adhesive should be of a composition as hereinbefore described and limited in thickness to a maximum of between 0.00005 and 0.0005 inch, and

2. (2) The applied phenolic composition should be heated before calendering until it has gelled.

The above requirements may be carried out on line prior to calendering with the flexible sheet advanced at a rate of over 10 ft/min and up to 30 ft/min. On line operation requires the resin to be dried and heated in unit 19 representing an air circulating oven or an IR heater. The temperature of the air circulating oven should be between 105° C. to 110° C. with the length of the oven selected to heat the resin for five minutes. Alternatively the oven may be raised to a temperature of between 210-220° C. with the resin treated for only for 30 seconds. Using an IR heater a peak temperature of about 165° C. is required for an application of only five seconds. These conditions apply only for the very thin coatings as specified in the above paragraph (1).

The resin may be applied full strength with a Mayer bar to the desired thickness or diluted with 100-200 parts solvent to 100 parts resin and painted on with a brush or roller. It is necessary to apply the resin to the metal surface to form a bond between metal and flexible graphite whereas in the case of two flexible graphite sheets both graphite sheets should be coated with resin adhesive.

Provided the above process constraints are followed the thin film of resin adhesive will be properly gelled before calendering and may be cured thereafter at a temperature of up to 242° C. in minutes and on-line depending upon thickness to produce a blister-free laminate.

What is claimed is:

1. A method for fabricating a bonded laminate with said laminate composed of a first sheet of metal and a second sheet of flexible graphite which is essentially non-porous in the direction transverse to the plane of the sheet and has a density of about 70 lbs. per cubic foot up to the theoretical density of graphite, said method comprising the steps of:
preparing a fluid adhesive composition comprising a phenolic resin, a diluent selected from the group consisting of isopropanol, isopropyl alcohol and methyl ethyl ketone and a compound of natural or synthetic rubber;
applying said fluid adhesive composition to said first sheet of metal to form a fluid adhesive layer with a maximum thickness of between 0.00005 and 0.0005 inch;
heating said resin containing adhesive layer until it has gelled;
feeding said selected first sheet having said gelled adhesive layer simultaneously with said second sheet of flexible graphite which is essentially non-porous in the direction transverse to the plane of the flexible graphite sheet through the pressure rolls of a calender roll assembly in a superimposed relationship;
discharging an adhesive layer bonded laminate of flexible graphite and metal from said calender roll assembly; and
curing the resin contained in the adhesive layer bonded laminate to cause polymerization of the resin.

2. A method as defined in claim 1 wherein said pressure rolls are preheated to a temperature of between 100° F. to 300° F.

3. A method as defined in claim 2 wherein said pressure rolls are adjusted in said calendar roll assembly to apply a pressure of between 100 to 200 psi to said laminate.

4. A method as defined in claim 3 wherein said fluid adhesive composition is dried and heated in an oven or IR heater while advancing said first sheet at a rate above 10 ft/min.

5. A method as defined in claim 4 wherein said adhesive composition contains up to 10% by weight of a natural or synthetic rubber.
